(19) United States
(12) Patent Application Publication
(10) Pub. No.: US 2005/0008314 A1
(43) Pub. Date: Jan. 13, 2005

(54) Fabrication of integrated circuit

(76) Inventor: John Paul Drake, Lambourn (GB)

Correspondence Address: Fleshner & Kim, PO Box 221200, Chantilly, VA, 22151-1200, US

(21) Appl. No.: 10/432,526

(22) PCT Filed: Oct. 25, 2001
(86) PCT No.: PCT/GB01/04730

(30) Foreign Application Priority Data
Nov. 24, 2000 (GB) 0028679.9

(51) Int. Cl. G02B 6/10

(52) U.S. Cl. 385/129; 216/2

(57) ABSTRACT

A method of fabricating an integrated device on a chip comprising first and second features (A, B), the second feature, B, having greater dimension and/or being of coarser design than the first feature A. The method involves the steps of: depositing a resist onto the chip, the resist being of a type that forms a thinner deposit on larger or coarser features than on smaller or finer features; treating the resist in dependence upon the thickness thereof to render it susceptible to a subsequent etching step, the thicker areas of resist being treated for a longer period of time or by a more intense treatment than the thinner areas of resist; and etching the treated areas of the resist to form a mask for use in the fabrication of said first and second features (A, B), on the chip.

### TECHNICAL FIELD

This invention relates to a method of fabricating an integrated circuit and to an integrated optical circuit fabricated thereby.

### BACKGROUND ART

The fabrication of integrated circuits, e.g. comprising optical waveguides in silicon, is well established using conventional semi-conductor technologies such as wet and dry etching. However, some devices require a mixture of relatively coarse and relatively fine features to be formed on the same chip. This can pose problems in the fabrication of the device because of the physical properties inherent in the masking materials commonly used.

This problem is exemplified by the masking procedure associated with making a fine taper of the type used to provide a low loss optical coupling between an optical fibre and a silicon waveguide, e.g. of the type described in U.S. Pat. No. 6,108,478.

### DISCLOSURE OF INVENTION

This invention seeks to provide a method of fabricating an integrated circuit, and a device fabricated thereby, which helps reduce such problems.

A method of fabricating an integrated device on a chip comprising first and second features the second feature having greater dimensions and/or being of coarser design than the first feature, the method involving the steps of: depositing a resist onto the chip, the resist being of a type that forms a thinner deposit on larger or coarser features than on smaller or finer features; treating the resist in dependence upon the thickness thereof to render it susceptible to a subsequent etching step, the thicker areas of resist being treated for a longer period of time or by a more intense treatment than the thinner areas of resist; and etching the treated areas of the resist to form a mask for use in fabrication of said first and second features on the chip.

According to a second aspect of the invention, there is provided an integrated optical device fabricated by the above method, the device comprising, two areas, a first area which includes said first feature and a second area which includes said second feature, and comprising a component which extends from the first area to the second area wherein at least one substantially non-functional feature is formed on the component at a position where the first and second areas meet.

Other preferred and optional features of the invention will be apparent from the following description and the subsidiary claims of the specification.

### BRIEF DESCRIPTION OF DRAWINGS

The invention will now be further described merely by way of example, with reference to the accompanying drawings, in which:

FIG. 1 is a perspective view of an integrated optical device according to one embodiment of the invention;

FIG. 2 is a plan view of the device shown in FIG. 1;

FIGS. 3 and 4 illustrate a series of steps in the fabrication of a first and second areas, respectively, of a device such as that shown in FIGS. 1 and 2.

### BEST MODE OF CARRYING OUT THE INVENTION

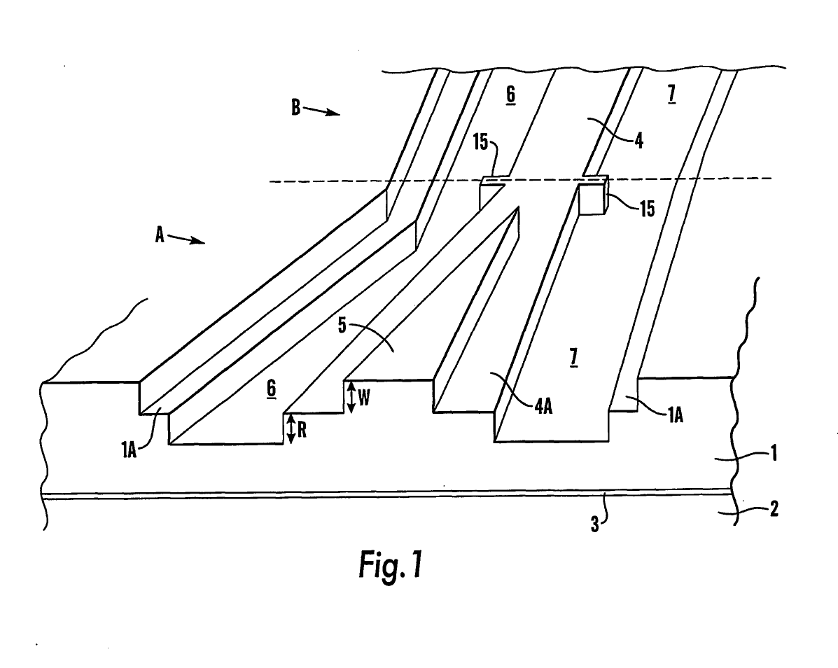

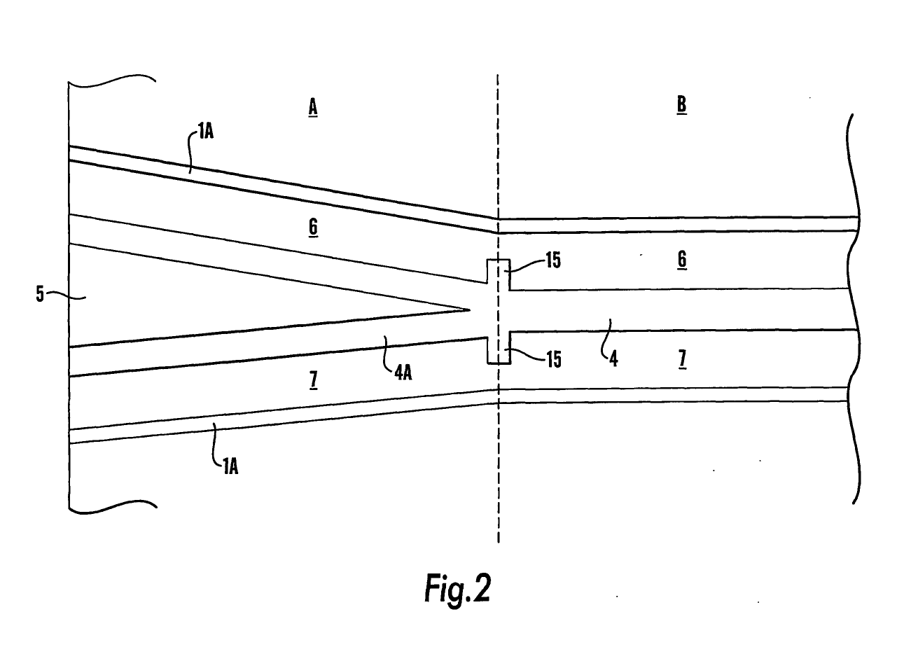

The integrated optical device shown in FIGS. 1 and 2 is fabricated on a silicon-on-insulator (SOI) chip, comprising a layer of silicon 1 separated from a substrate 2, which may also be of silicon, by an insulating layer 3, typically of silicon dioxide.

The device illustrated comprises a rib waveguide 4 with a tapered waveguide structure at one end thereof comprising a wedge shaped portion 5 formed on top of a tapering portion 4A of the rib waveguide 4. These latter two components 4, and 4A, are defined between trenches 6 and 7 etched in the silicon layer 1. A tapered waveguide structure somewhat similar to that shown is further described in U.S. Pat. No. 6,108,478, the disclosure of which is incorporated herein.

The rib of the rib waveguide 4 typically has a height R (measured from the bottom of the trenches 6 and 7 to the top surface of the rib) of about 1.5 microns. The wedge shaped portion 5 typically has a height W (measured from the top surface of the rib to the top surface of the wedge shaped portion) of about 5 microns but, in some cases, may be 8 microns or more, and a length of about 1000 microns.

The trenches 6 and 7 typically have a width of about 60 microns and the layer of silicon 1 between the bottom of the trenches 6 and 7 and the oxide layer 3 is typically about 2.8 microns thick.

Such a wedge shaped structure is used to provide a low loss coupling between an optical fibre (not shown) and the rib waveguide 4 as discussed in U.S. Pat. No. 6,108,478.

Fabrication of such a structure in which the total etch depth from the upper surface of the silicon layer 1 to the bottom of the trenches 6 and 7 may typically be in the range 6 to 10 microns presents difficulties as the accuracy with which features can be formed decreases with the increase in etch depth.

One solution to this difficulty is described in GB9924098.8 (publication No. GB2355312A) the disclosure of which is also incorporated herein. The fabrication process described herein provides an alternative solution to these difficulties.

A device such as that shown in FIGS. 1 and 2 is preferably etched in two-stages, a first stage in which the wedge shaped portion 5 is defined and the positions of the trenches 6 and 7 defined and a second stage in which the trenches 6 and 7 are etched to form the rib waveguide 4.

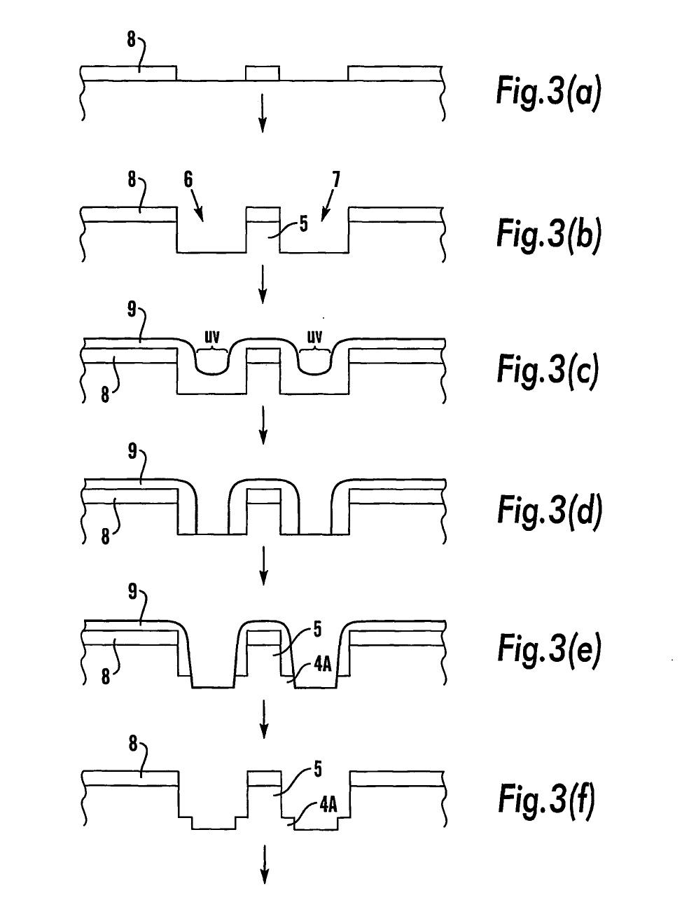

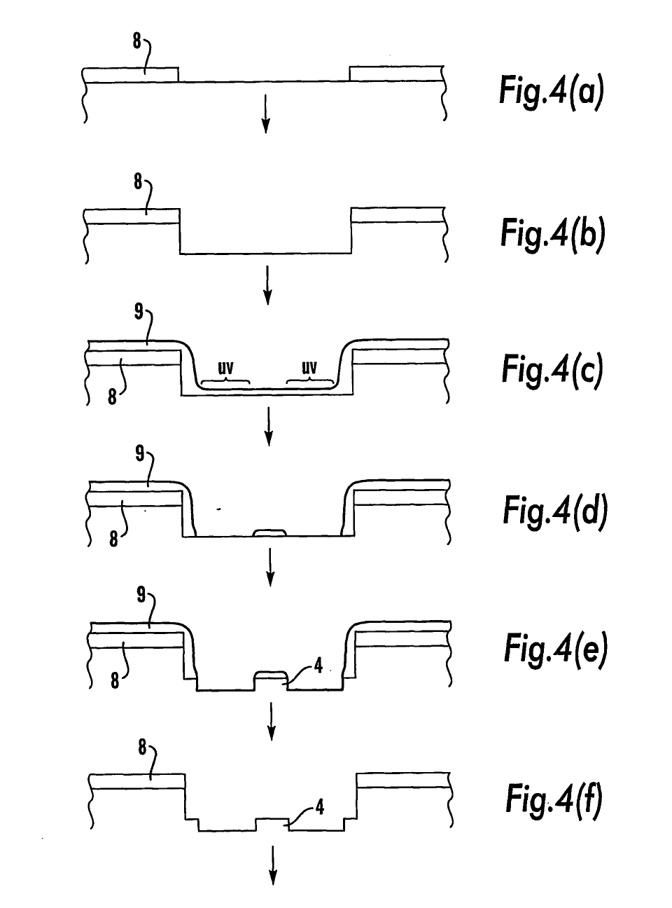

Such a two-stage process will be described further with reference to FIGS. 3 and 4 in which FIG. 3 illustrates the steps in relation to a first area A of the device encompassing the wedge shaped structure at the end of the waveguide 4 and FIG. 4 illustrates the step in relation to a second area B of the device encompassing the part of the waveguide 4 having parallel sides. The boundary between areas A and B is shown by the dashed line in FIGS. 1 and 2.

In the first step illustrated by FIGS. 3(a) and 4(a), the surface of the silicon layer 1 is covered in appropriate regions by an oxide layer 8.

Then, as shown in FIGS. 3(b) and 4(b), the oxide layer 8 is used as a mask for dry etching to define the wedge shaped portion 5 (shown in FIG. 3(b)) and the trenches 6 and 7, but only to a depth corresponding to the top surface of the rib of the rib waveguide 4.

Then, as shown in FIGS. 3(c) and 4(c), an optical resist 9, e.g. a photosensitive material such as Novalak™ resin, in liquid form, is spread across the device by a conventional spinning process and then baked. Such a resist has a tendency to deposit as a thicker layer in fine, narrow features, than it does in coarse, wide features. Thus, it deposits in a thicker layer in corners and crevices of the relatively narrow portions of trenches 6 and 7 on each side of the wedge shaped portion 5 in area A of the device (FIG. 3(c)) and in a thinner layer in the wider, flatter areas of the trench formed in area B of the device (FIG. 4(c)).

Areas of the resist 9 which are to be removed are then exposed to ultra violet (UV) light through a mask (not shown) in the areas being marked UV in FIGS. 3(c) and 4(c). The areas of resist exposed to UV light are then removed by a leaching chemical as shown in FIGS. 3(d) and 4(d) to expose areas of the silicon layer 1 at the bottom of the trenches 6 and 7 formed in step (b).

These exposed areas of the silicon layer 1 are then etched by a conventional, typically dry, etch process as shown in FIGS. 3(e) and 4(e) to complete the etching of trenches 6 and 7 and thus form both portions 4 and 4A of the rib waveguide.

As shown in FIGS. 3(e) and 4(e), the areas of resist exposed to UV are approximately central within the trenches 6 and 7 where the thickness of the resist is fairly uniform and the areas are narrower than the width of the trenches. This avoids the need to expose the very thick parts of the photoresist at the sides of the trenches 6 and 7. This results in steps 1A being left at the outer edges of the trenches 6 and 7 of similar height to the steps on the inner sides of the trenches 6 and 7 which form the tapered part 4A of the rib waveguide. The steps 1A are also shown in FIG. 1.

The remaining parts of the resist 9 are then removed by conventional means, e.g. by a wet chemical etch or plasma strip, as illustrated in FIGS. 3(f) and 4(f) to leave a structure as shown in FIGS. 1 and 2. The device may then be subject to further process steps, e.g. covering with an oxide layer, but these steps are not relevant to the present invention so will not be described further.

As indicated above, the resist 9 tends to deposit as a thicker layer in area A of the device that it does in area B (the difference is shown exaggerated in FIGS. 3(c) and 4(c). To achieve satisfactory treatment of the resist so the relevant parts thereof are removed in step (d), the thicker areas of resist 9 in area A need to be subjected to UV light for a longer period of time than the thinner areas of resist 9 in area B. Inadequate exposure of the resist would result in inadequate removal of resist in step (d) whereas over exposure of the resist results in a too wide an area of resist being removed as a result of stray (e.g. reflected and refracted) UV light causing undesirable reaction in the resist adjacent the area intended to be removed. Furthermore, if a thin area of exposed resist is treated with more leaching chemical than necessary to remove the exposed area, non exposed resist will start to be leached causing inaccurate and unreliable results.

The thicker area of resist may be subjected to a longer exposure time to UV light than the thinner areas, as mentioned above. Alternatively, or additionally, the thicker areas of resist may be subjected to a more intense exposure to UV light that the thinner areas. Thus, the manufacture of a device such as that shown in FIGS. 1 and 2 involves a multi-stage exposure process so that some areas are exposed more than other areas.

In the example described in relation to FIGS. 2 and 3, a two stage process in used: area A being subjected to a greater exposure of UV light than area B. This may be achieved by exposing areas A and B separately or by exposing both areas together, and then subjecting area A, but not area B, to further exposure. However, in more complex products, a greater number of areas may require differential exposure and a greater number of exposure stages may be used.

The use of such differential exposures depending on the thickness of the resist thus enables product quality to be improved and the usable chip yield to be increased.

The technique described above can be applied to any form of integrated circuit comprising both relatively small or fine features and relatively large or coarse features. This is particularly the case in a device in which the coarse features have dimensions perpendicular to the plane of the chip of 5 or more microns. However, it may also be applicable to devices in which the coarse features have dimensions perpendicular to the plane of the chip of at least 2 or 3 microns.

In practice, the dimensions of an area of resist to be exposed to UV light needs to be adjusted to allow for shrinkage of the resist which occurs after the exposure, developing and baking steps. However, it is found that the degree of shrinkage varies with the thickness of the resist; the shrinkage tending to be greater with thicker layers of resist. However, the degree of shrinkage is not easily predictable. As a result of this, at the position where two areas subjected to different exposures meet, a discontinuity, e.g. a small step or notch, tend to form due to the differential shrinkage of the resist either side of the boundary. Such a discontinuity is undesirable as its size may be variable and it may cause a significant perturbation in operation of the device being fabricated.

For instance, in the case of an optical rib waveguide which extends from one area to the other area, a discontinuity in the width of the waveguide may arise where the waveguide crosses the boundary between the two areas. Such a discontinuity or step in the side faces of a rib waveguide may give rise to a significant loss of light from the waveguide.

To overcome this problem, the initial mask may be designed to provide a substantially non-functional feature, which does not give rise to any significant perturbation of the operation of the device, at the boundary between the areas subjected to different exposures. In the case of a rib waveguide discussed above, a small projection 15 may be provided on each side of the rib 4 at the point where the rib waveguide crosses the boundary between areas A and B, as shown in FIGS. 1 and 2. Such small projections have no significant effect upon an optical signal transmitted along the waveguide. Thus, a perturbation in the size of the projections at the boundary between the two areas also has no significant effect upon the optical signal.

As shown in FIGS. 1 and 2, the boundary between areas A and B also coincides with the junction between the tapered section 4A of the rib waveguide in area A with the section 4 having parallel sides in area B. The projections 15 are thus formed at this point. Preferably, the projections 15 have a depth the same as that of the waveguide 4, as shown, a width of about 1.5 microns and extend along the boundary between areas A and B substantially perpendicular to the sides of the waveguide 4, for a distance of about 5 microns.

The projections 15 thus allows for small differences in shrinkage rate between two exposed areas by providing a transition or grading feature at the boundary between the two areas which does not cause significant light loss in the finished device.

It will be appreciated that the need to provide non-functional features, such as the projections 15, at the boundary between areas of the chip subjected to different exposures, will depend on the nature of the device and the nature of components which cross the boundary. Thus, such features will not always be required and may be omitted where the perturbation caused by a discontinuity may be relatively small.

1. A method of fabricating an integrated device on a chip comprising first and second features the second feature having greater dimensions and/or being of coarser design than the first feature, the method involving the steps of: depositing a resist onto the chip, the resist being of a type that forms a thinner deposit on larger or coarser features than on smaller or finer features; treating the resist in dependence upon the thickness thereof to render it susceptible to a subsequent etching step, the thicker areas of resist being treated for a longer period of time or by a more intense treatment than the thinner areas of resist; and etching the treated areas of the resist to form a mask for use in fabrication of said first and second features on the chip.

2-20. (Cancelled).

21. The method as claimed in claim 1 wherein a first etch step is used to at least partially define a first mask, and a second etch step is subsequently used to define further the first and second features through the mask formed from said treated areas of resist.

22. The method as claimed in claim 21 wherein the first mask comprises at least one relatively narrow etch window for fabrication of the first feature and at least one relatively wide etch window for fabrication of the second feature.

23. The method as claimed in claim 21 wherein the first etch step comprises a dry etch process.

24. The method as claimed in claim 21 wherein the first etch step comprises etching through a mask formed in an oxide layer.

25. The method as claimed in claim 24 wherein said treatment comprises exposing selected areas of resist to ultra-violet light.

26. The method as claimed in claim 25 wherein said selected areas of resist are etched away following exposure to ultra-violet light.

27. The method as claimed in claim 25 wherein said resist comprises a resin which is applied in liquid form.

28. The method as claimed in claim 1 wherein two areas of the resist are defined, a first area which includes said first feature and a second area which includes said second feature, the first area being subjected to said treatment for a longer period of time and/or by a more intense treatment than said second area, the integrated circuit to be formed comprising a component which extends from the first area to the second area wherein at least one substantially non-functional feature is formed on the component at a position where the first and second areas meet.

29. The method as claimed in claim 28 wherein said component is a rib waveguide and the substantially non-functional feature comprises a projection formed on each side of the waveguide at the position where the first and second areas meet.

30. The method as claimed in claim 1 wherein the integrated device comprises an optical device formed in silicon.

31. The method as claimed in claim 30 wherein the device is formed on a silicon-on-insulator chip.

32. The method as claimed in claim 1 wherein said second feature has greater dimensions in a direction perpendicular to the plane of the chip than said first feature.

33. The method as claimed in claim 32 wherein the first feature has a dimension, from a top surface thereof to the base thereof, in a direction perpendicular to the plane of the chip, of at least 2 microns.

34. The method as claimed in claim 1 wherein the first feature comprises a tapered rib waveguide.

35. The method as claimed in claim 1 wherein the second feature comprises a rib waveguide having substantially parallel sides.

36. An integrated optical device fabricated by a method as claimed in claim 1, the device comprising, two areas, a first area which includes said first feature and second area which includes said second feature, and comprising a component which extends from the first area to the second area wherein at least one substantially non-functional feature is formed on the component at a position where the first and second areas meet.

37. An integrated optical device as claimed in claim 36 wherein said component comprises a rib waveguide and said non-functional feature comprises a projection formed on each side of the waveguide.
